(19) United States
(12) Patent Application Publication
(10) Pub. No.: US 2017/0055767 A1
(43) Pub. Date: Mar. 2, 2017

(54) Vertical Rotisserie Adaptor

(71) Applicant: Keith Brown, Fort Wayne, IN (US)

(72) Inventor: Keith Brown, Fort Wayne, IN (US)

(21) Appl. No.: 14/836,519

(22) Filed: Aug. 26, 2015

(51) Int. Cl. A47J 37/04

(52) U.S. Cl. CPC A47J 37/041

(57) ABSTRACT

A universal cooking assembly for rotating vertically disposed food over a horizontally disposed heat source, said cooking assembly comprising: a horizontally disposed rotisserie rod; a first skewer apparatus; a second skewer apparatus; and a handle mechanically connected to the rotisserie rod for rotating the same about its axis.

### BACKGROUND

1. Field of the Invention

The present invention relates to cooking apparatuses and, more particularly, to rotisserie assemblies.

2. Description of the Related Art

U.S. Pat. No. 3,559,565 discloses a fuel receptacle rotatably that mounts a frame about a vertical axis which in turn removably supports a food holding grill assembly or rotisserie through which food may be controllably exposed to heat and smoke evolved from the receptacle. The grill assembly may be angularly displaced to a withdrawn position and to invert the food when positioned over the receptacle. The rotisserie rotates the food over the receptacle below a hood that may be mounted on the rotisserie frame.

U.S. Pat. No. 3,563,159 discloses a rotisserie or cooking appliance that includes a rotary drum that has openings therein, a shell or housing surrounding the drum and provided with a plurality of sections that are provided with members for holding food products thereon that are to be barbecued or cooked and a novel means for applying heat to the food products.

U.S. Pat. No. 3,602,131 discloses ovens of the type used in household ranges and more particularly to ranges of the self-cleaning or pyrolytic type having a rotisserie using an external drive motor.

U.S. Pat. No. 3,604,341 discloses a vertical rotisserie which consists of an electric barbecue arrangement having an arcuate heating element in the general focus of which a rotatable spit is mounted. The axis is vertical so as to protect the heating element from drippings which are collected in a drip pan under the end of the spit.

U.S. Pat. No. 3,611,912 discloses a portable grill comprising a hinged carrying case openable to form an elongated planar grill base or counter top, legs swingable out of the case to support the base at an elevated horizontal position, and sidewall forming members fitting in the case and attachable to the top of the base to form supports for hot coal holding racks also fitting in the case and selectively mountable on the sidewalls either parallel to the base or perpendicular thereto for grilling or rotisserie operation.

U.S. Pat. No. 3,742,839 discloses a rotisserie having a pair of vertical spit support strips having screw clamps at their lower ends for securing on the rim of a barbecue grill firebox (or optionally to the upper ends of wood stakes driven into the ground). The support strips are provided with at least three vertically spaced apart inverted L-shaped slots including horizontal portions open at one edge of each support strip and vertical portions extending downwardly from the respective horizontal portions. The bottom or middle slot of one support strip constitutes a support for a self-contained battery-operated spit drive unit which has its spit drive shaft extending through the vertical portion of a slot above that which supports the drive unit. The end of the spit remote from the drive unit is supported by the bottom of the vertical portion of the middle or top slot in the other support strip. The adjustable meat holders on the spit are of simple form having straight divergent prongs embedded in the meat being barbecued.

U.S. Pat. No. 3,832,989 discloses a charcoal firebox for use as an accessory with a rotisserie, brazier or the like that comprises a metallic enclosure for a layer of burning coals. The enclosure is defined by a grill removably mounted to an open face pan. The grill is formed of spring tensionable material and is spaced from and confronts the central reflector plate of the pan. The spacing between grill and central plate is less at the bottom of the grill than at the top so that an unburned or newly ignited coal fits easily between the plate and the grill at the top of the grill but such that coals at the bottom of the grill bow the grill forwardly outwardly from the central plate, spring tensioning the grill and generating a grill restoring force causing the lower end of the grill to exert rearwardly directed force on the adjacent coals, retaining them against the central plate as the spring tensioned grill bottom moves rearwardly to follow the coals toward the central plate retaining them against the central plate as the coals are reduced in size by combustion. The disclosed structure assures that coals adjacent the top of the grill do not drop to the bottom until the coals adjacent the bottom are substantially reduced in size thereby preserving the single layer depth of coals for a prolonged period. Divider ribs on the central reflector plate divide the enclosure into three compartments, permitting burning coals to be concentrated in one or more of these compartments for improved cooking efficiency. The firebox has a handle assembly extending forwardly from the pan to permit the pan to be placed at various angles relative to the rotisserie to achieve improved cooking results. The handle assembly is weighted sufficiently that when the handle assembly is raised and lowered relative to a horizontal plane to change the angle of the pan relative to the plane, the pan will not tip rearwardly. Support means is mounted to the handle assembly and is extendable toward the brazier bowl to retain the handle at a plurality of predetermined distances above the brazier, controlling the angle between pan and brazier bowl for optimum cooking results.

U.S. Pat. No. 3,866,527 discloses a rotisserie intended for mounting on a standard broiler and which comprises a rectangular frame presenting side members of hollow construction. Received in each side member is a drive screw which is driven by a motor on one end of the frame. Each side member has an inner vertical wall which is formed with a plurality of large circular openings uniformly spaced apart. Each side member also has an outer vertical wall formed with uniformly spaced small openings in axial alignment with the openings in the inner wall. A driving cup is journaled in each pair of aligned openings. Each cup is formed with an external worm gear that meshes with a drive screw. Each cup opens onto the outer face of the inner wall and presents a non-circular recess. A sleeve for each cup is swingably mounted on a bracket secured to said inner wall above an opening therein. A spit drive shaft passes through this sleeve and its inner end carries a member corresponding in shape to the cup recess in which it is received. A spring clamp is mounted on the inner end of each spit drive shaft and detachably receives the head of a split. A supporting rod extends longitudinally of the frame midway the side members and is notched to supportingly receive the ends of spits when the latter are in horizontal positions. The spit carrying portions of the frame is of a standard size having a number of spits. The drive screws project beyond one end of the frame where they are adapted to be connected to another frame having an additional number of spits.

U.S. Pat. No. 4,108,055 discloses a mobile broiler rotisserie apparatus including a trailer frame having road engaging wheels thereon and a hitch for connection to a vehicle. The trailer frame has an open top chamber having sidewalls and a bottom wall mounted thereon with a pair of spaced support brackets being secured to opposed walls of the chamber adjacent the upper edges thereof. Rotatable food supporting devices are mounted on the support brackets in spaced relation from the bottom wall and vertically spaced above a controllable heat generator positioned in the spacing between the rotatable food supporting devices and the bottom wall for cooking foods supported on the rotatable food supporting devices. A hood is pivotally secured to one of the upper edges of the open top chamber and is movable between open and closed positions relative to the open top of the chamber. An elongated trough is mounted in the chamber in vertical alignment with the rotatable food supporting device and is inclined from one end of the chamber downwardly toward and out through an opening in the wall of the chamber at the opposite end thereof. A drive mechanism is operatively connected to the rotatable food supporting device and has a rotatable output characteristic such that the juice from food mounted on the rotatable food supporting device will fall therefrom during cooking and into the trough. The heat from the heat generator will maintain the collected juice in the trough in a liquid form so that it will flow down the incline of the trough and out through the opening for collection.

U.S. Pat. No. 4,114,523 discloses a roasting oven having a broiling element near the top of the oven liner and a rotisserie spit adapted to be supported in an elevated position from a wire frame in a broil pan seated on an oven rack. The spit is provided with a food-supporting wire basket that is attached to the spit adjacent one side edge of the basket. The basket is positioned horizontally in the oven, closely adjacent the underside of the broiling element. One end of the spit is fitted into a chuck positioned through the back wall of the oven. The chuck is driven by an oscillatory motor-drive mechanism mounted behind the oven liner, there being a long dwell period after each short oscillating movement. Hence, the food basket is capable of being inverted by the action of a downward swinging oscillating movement through an angle of 180° so as to broil both sides of the food in the basket at a distance closely adjacent the broiling element.

U.S. Pat. No. 4,158,992 discloses a combination hibachi-type grill and rotisserie that comprises at least one fuel tray mounted on a base. Securing means demountably secures a pair of brackets to opposite sides of the tray in vertical arrangement. Mounting means on the brackets rotatably receives a spit longitudinally of the tray. Drive means coupled to the spit drives the same at a predetermined rotational speed.

U.S. Pat. No. 4,436,024 discloses a spit vertically adjustably supported at one end by horizontal coaxial tubular members and a vertically adjustable standard on a fireplace hearth. The other end of the spit is removably inserted into apertures formed in a post secured to the back wall of a fireplace for horizontally supporting the spit. A crank handle, having a set screw equipped hub, surrounds the end of the tubular members opposite the fireplace back wall permitting manual or rotisserie motor drive for the spit.

U.S. Pat. No. 4,442,763 discloses a meat roaster with skeleton support which is free standing, capable of quick assembly and is adapted to be fully enclosed by sheet or foil-type metal for cooking large food items. The skeleton support comprises lower, intermediate and upper frame means. The intermediate frame means includes means for rotationally supporting a wide variety of spit basket styles and means for adjusting the height of the spit basket. The upper frame means includes opposing hoop-like members interconnected by a longitudinal support and which cooperate to form a dome-shaped ceiling when enclosed. A firebox chamber is formed below the dome-shaped ceiling by enclosing the intermediate frame means. The upper frame means is manually disengageable from the intermediate frame means allowing access to the food during roasting. The lower frame means is capable of supporting charcoal baskets in the firebox chamber below and to the sides of a supported spit basket. The frame means are capable of full disassembly.

U.S. Pat. No. 4,462,306 discloses an outdoor cooking grill having a bottom grate supported in an iron framework with a food grill of parallel heat conductive bars capable of being raised and lowered relative to the grate. The apparatus includes a curved heat reflective back plate providing insulative characteristics to protect the back closure. Rotisserie supports are provided on a horizontal lift support frame which can serve selectively as a grill support and a rotisserie support. Specific lock devices are provided for rotisserie rods to position the rods in any of a plurality of positions. A composite lift bracket serves also as a rotisserie support.

U.S. Pat. No. 4,505,195 discloses a rotisserie including a pair of supporting frames that rotatably support a cradle having means for vertically adjusting the opposite ends of the rotating cradle so that the position of the cradle with respect to a source of heat may be varied. In the selected embodiment the cradle comprises a pair of end plates with a plurality of rods extending between the end plates for securing food to be cooked thereto and in which a selected number of the rods may be moved radially inward to clamp the food in position.

U.S. Pat. No. 4,512,248 discloses a rotisserie cooker having a multi-sided base, a vertical spit mounted for rotation thereon and upstanding tapered wall sections and a roof section forming a cooking area, heating means on the rear walls of the cooker and a pair of bifold closure doors for the front opening of a cooking compartment. Each bifold door comprises a solid side panel and a front panel having a window therein, each side and front panel tapering upwardly to define with the base and wall sections of the cooker an external shape of generally hexagonal cross-section throughout the height of the cooker.

U.S. Pat. No. 4,561,418 discloses a barbecue grill for outdoor cooking that has vertical spaced heating panels between which foodstuffs can be supported for cooking. One of the panels is slidable towards and away from the other panel to control the amount of heat supplied to the cooking area between the panels, and is pivotable outwards away from the cooking area about a vertical pivot axis at one side edge for easier access to the cooking area.

U.S. Pat. No. 4,562,771 discloses a flip-over drive system for a removable oven rotisserie comprising drive means, gear train means driven by the drive means, cam means mechanically coupled to the gear train means for rotation in response to the driving of the gear train means by the drive means, escapement means position for periodic engagement with the cam means, and socket means mechanically coupled to the escapement means. The socket means is configured to receive a rotisserie shaft therein, whereupon the socket means and the rotisserie shaft upon being received therein are rotated to a first predetermined angular position upon engagement of the escapement means with the cam means and remain in the first predetermined angular position for a predetermined dwell period until the cam means re-engages the escapement means whereupon the socket means and the rotisserie shaft are rotated to a second predetermined angular position and remain in the second predetermined angular position for a predetermined dwell period.

U.S. Pat. No. 4,572,062 discloses a roasting machine for roasting relatively large items of food, such as small pigs or the like. The machine includes a pair of side frame members by means of which the roasting machine may be supported for transportation along the ground or rested on the ground. A pair of end supports is secured to the side frame members and have notches which carry handlebars, which handlebars in turn carry a suspended firebox between the side frame members. The spit includes a hollow drum which receives the legs of H-shaped wire skewers to support the food on the spit. A special clamp mechanism is provided for retaining the spit drum on the support rod.

U.S. Pat. No. 4,593,613 discloses a rotisserie which includes a pair of supporting frames that rotatably support a cradle that has means for vertically adjusting the opposite ends of the rotating cradle so that the position of the cradle with respect to a source of heat may be varied. The cradle comprises a pair of end plates with a plurality of rods extending between the end plates for securing food to be cooked thereto and in which a selected number of the rods may be moved radially inward to clamp the food in position.

U.S. Pat. No. 4,924,766 discloses a rotisserie assembly for barbecue grills in which the motor support bracket can be arranged to support the motor in a plurality of vertically adjusted positions and the rod support bracket includes a plurality of slots for receiving the rotisserie rod. The motor bracket includes an adapter plate that can be inverted for providing two adjusted positions and which can be omitted for providing a third position.

U.S. Pat. No. 4,979,439 discloses a rotisserie for the controlled cooking of chicken carcasses or other meats in which a planar meat holding rack is rotatively mounted within a circular chamber. The planar rack is held in a generally vertical plane with carcasses mounted on either side of the rack. The rack rotates about a horizontal axis passing through its center of gravity, thus exposing the carcasses to two broilers mounted in the opposite walls of the chamber equidistantly from the rack. In the base of the rotisserie, a boiler generates a steady stream of steam which is injected into the cooking chamber to prevent charring of the meat and provide for a more even and thorough cooking. An injecting tool allows the operator of the rotisserie to spray or inject sauces or seasonings into the carcasses before or after cooking.

U.S. Pat. No. 5,025,715 discloses a tripod stand structured for supporting food holding equipment over a fire pan containing a fire, or an open campfire. The tripod has three support legs, each formed of a plurality of separable sections which snap together. The upper portion of each leg is hingedly affixed to a central collar. The central collar further defines a central bore structured for retaining a vertically oriented center rigid shaft. The lower end of the center rigid shaft is structured for releasably supporting one of several food holding accessories such as a grill, a battery powered rotisserie or a shish kebob apparatus over the fire. The central collar allows the center rigid shaft to be removed or variably adjusted in height over a wide range. Temporary stationary affixment of the center rigid shaft within the central collar is made with the use of a threadably engaged L-shaped handle, one end of which extends through a threaded bore in the sidewall of the central collar. With the center rigid shaft removed from the central collar, a vertical slot within the sidewall of the collar is exposed for releasably and adjustably retaining one end of a length of chain. The distal end of the chain is affixed with a hook for suspending a cooking pot. The tripod stand and food holding equipment can be easily disassembled and stored within the provided fire pan, which in turn can then be stored within a handled fabric carrying case.

U.S. Pat. No. 5,101,715 discloses a rotisserie comprising a rearrangement of the infra-red heaters to a position not in direct view of the operator, so as to not expose him to its infra-red rays, and the provision of a plurality of circular food holders adjustably positionable on a vertically oriented rotisserie spit on which small items of food can be supported with the aid of food stakes. Small drip dispensers can also be disposed on the circular food holders to supply cooking fluids to food articles hung below them.

U.S. Pat. No. 5,140,896 discloses an improved rotisserie grill comprising an elongated rectangular framework having four vertical legs, one in each corner and two side cross members, each extending horizontally between two legs. A rotatable spit is supported longitudinally above the framework. An electric motor is supported on the framework to rotate the spit. A semi-cylindrical fire bowl having a curved inner surface is affixed to the framework with the side cross members supporting the bottom ends of the fire bowl. A grate is carried in the fire bowl to hold fuel thereon so that when the fuel is burned the curved inner surface of the fire bowl will reflect heat towards the rotating spit.

U.S. Pat. No. 5,224,676 discloses a universal rotisserie mounting bracket assembly, the assembly mounting the motor on a side shelf of a barbecue grill cart for distancing the motor from the intense heat of the grill and prolonging its life. The bracket assembly is designed for vertical adjustability of the motor, ensuring compatibility with a plurality of differently configured grill castings and facilitating vertical adjustment of the rod for adjusting cooking times.

U.S. Pat. No. 5,460,080 discloses a mobile rotisserie for mass cooking of edible vertebrate products, characterized by a wheel-mounted, open pit wherein a spit conveyor travels from end to end and plural spits engage the conveyor. The spits are rapidly rotated simultaneously as they travel the length of the rotisserie unit. Cooking products are removably impaled while being releasably compressed on the spits by retainer and strap assemblies, each of which is held upon traveling rods, the latter of which engage the spit conveyor. The travelling rods and spits, per se, are removable during operation and successively transportable with the cooked product from the rotisserie.

U.S. Pat. No. 5,515,774 discloses a rotary cooker that includes a cabinet assembly having a bottom, a top, opposite sidewalls, a front wall and a back wall. A door opening is formed in the front wall and is selectively closed by a door hingedly mounted on the front wall. A spit/rotisserie assembly including a drive shaft rotatably received in bearings is mounted in the cabinet assembly sidewalls, and further includes a rotisserie selectively mounted on the drive shaft for operation in a rotisserie configuration. The rotisserie can be removed from the drive shaft for operation in a spit cooking configuration. A drive assembly includes a motor drivingly connected to the drive shaft, a battery for selectively powering the motor and a photovoltaic solar collector array for charging the battery.

U.S. Pat. No. 5,536,518 discloses a convertible barbecue capable of grill cooking and rotisserie cooking. The barbecue includes one or more radiants such as briquette trays for holding refractory briquettes underneath a food item to be cooked. In the grill-cooking mode, the briquette trays are supported horizontally underneath a grill rack, while in the rotisserie mode a front briquette tray is removed and a rear briquette tray is angled so as to be out from underneath a spit for rotisserie cooking of food items. In an alternative configuration both front and rear briquette trays may be repositioned toward the rotisserie spit.

U.S. Pat. No. 5,649,475 discloses a rotisserie assembly that comprises brackets for holding a rotisserie unit. The brackets are universally adaptable so that they can be used to support a rotisserie unit on a variety of grill styles and models. The rotisserie assembly further includes a handle for a rotisserie rod and forks that attach to a rotisserie rod and support food thereupon.

U.S. Pat. No. 5,711,209 discloses a barbecue stove having a grill, a cooking lid and/or an open top on a heater section. A stove door on a door end of the heater section is sized and shaped for receiving heater means such as wood, coal, charcoal, gas burners or electrical heating elements and select vapor-producing items. A chimney end of the heater section has a barbecue oven into which heat, smoke, oxidation vapors and/or water vapor generated in the heater section are directed for cooking meats and other foods selectively on designedly heat-circulation shelves that are positional selectively. An oven door provides entry to the barbecue oven from a design wall and/or walls. At a front of the heater section, a suspension rack is extended vertically upward from the stove top for suspending pins, rotisseries, and other means for positioning meats and/or other foods above the heater section. Mobility means such as wheels can be attached to bottoms of the stove and the oven. Although intended primarily for outdoor use, this barbecue stove can be used indoors by extending a chimney pipe from an exhaust outlet in a lid of the barbecue oven to an outdoor outlet.

U.S. Pat. No. 5,720,217 discloses a rotisserie apparatus and method of cooking food items. The rotisserie apparatus includes a housing containing a heat source for supplying heat to an area above the housing. A plurality of spit supports are positioned on the housing, and extend vertically upwardly from the housing. A plurality of horizontally-disposed spits are carried by the spit supports, and located in vertically-spaced relation above the heat source for holding respective food items to be cooked. Counter-rotating sprockets are operatively connected to the plurality of spits for rotating adjacent spits in opposite directions during cooking, and permitting contacting adjacent food items to counter-rotate away from each other after engaging without being inadvertently forced off the spits.

U.S. Pat. No. 5,761,991 discloses an adjustable rotisserie basket assembly for use in a rotisserie oven that includes a basket having a mount for mounting the basket in the rotisserie oven, a bottom surface for supporting a food item, and a clamp having a surface for adjustably contacting, compressing and stabilizing the food item within the basket. The clamp does not extend past the contacting surface in the direction of the food item, thus allowing the clamping means to adjust to the food item's unique dimensions.

U.S. Pat. No. 5,845,563 discloses a rotisserie cooking appliance that includes a base and attached wall in the form of a vertically bisected cylinder. The base contains a centrally-located spindle for the attachment thereon of a drip pan and a spit and basket assembly. The spit and basket assembly includes a circular wire basket for containing the food item to be cooked, with a spit attached to the center thereof The spit has an integral handle at the top to facilitate the insertion and removal of the spit and basket assembly from the rotisserie. An electric heating element is provided which is located to the rear of the rotisserie, which emits more thermal radiation near the bottom of the cooking chamber than at the top thereof A removable aluminum reflective element is configured behind the heating element to further direct thermal radiation towards the spit and basket assembly. A single door configured as a vertically bisected cylinder made of a transparent heat resistant plastic material is provided. When the door is in the closed position, a curved slot in the top thereof secures the spit and basket assembly in place.

U.S. Pat. No. 5,910,332 discloses a rotary broiler assembly that includes a rotisserie structure rotatable about a fixed axis. The rotisserie structure has a holding device radially spaced from the axis for holding a food item such as chicken thereon. When the rotisserie structure is rotated, the holding device revolves in an orbital fashion about the axis to define a path of orbital movement. A heat source is positioned within the path of orbital movement so that rotation of the rotisserie structure causes the food item to revolve about the heat source to thereby cook the food item.

U.S. Pat. No. 6,142,064 discloses a rotisserie including a countertop resting box-like enclosure housing a safety rear mounted heating element and a power rotated dual rod spit assembly. The gear driven spit assembly may be inserted and removed straight into and out of the enclosure without need for angling or coupling the assembly to a power drive socket. The spit assembly may also be mounted at various distances from the heating element to decrease cooking times. The open front of the enclosure is from time to time covered by an inclined glass panel door which may be opened in various ways to facilitate food insertion into and removal from the enclosure and which may be easily removed for cleaning or other purposes. The embodiment's design makes efficient use of valuable counter space by recessing back and raising off the countertop its controls. A contained light as well as room light emitted through the inclined glass door illuminate the enclosure's interior to make the rotisserie cooking into a taste tempting show. Two countertop supported sizes for the embodiment are suggested, one for larger families and entertaining, and the other for small families and singles.

U.S. Pat. No. 6,182,560 discloses a gas-fired or briquette-burning barbecue grill that outputs extremely high BTUs from a removable, vertical firebox that is backwardly inclined so as to provide a combination of direct and indirect heating. In addition, multiple cooking grids positioned at various vertical levels across the face of the firebox provide an enormous cooking area for grilling, broiling, and searing. Inclination minimizes ash avalanche during briquette burning and also increases the effective heating area applied to multiple cooking grids of gas-fired and briquette-burning grills. A top grid located directly over the firebox provides a surface for searing or high-temperature cooking (i.e., direct heating), a mid-level cooking grid provides medium temperature indirect and/or partial direct heating cooking, and a lower main cooking grid provides indirect medium temperature for broiling or baking. A pair of opposed insulated sidewalls on each side of a central heating area includes respective sets of rail guides which support cooking grids at varying distances from the firebox. The sidewalls also help confine heat in and about the cooking grids and may also support a removable, hinged cover lid that establishes an oven-like enclosure about the mid-level and main cooking grids to provide a baking/broiling chamber. Grid elements of the main cooking grid, which is downwardly inclined about three degrees toward the front of the gill, comprise oppositely facing channels that route grease drippings from cooking foodstuffs to a grease-catching receptacle. The firebox rests in a cradle or receptacle and is adapted to be easily removed by a grasp handle insertable in a surface of the firebox. A wire basket inside the metal firebox retains briquettes in spaced relation to the firebox walls thereby to provide an ash reservoir for briquettes as they burn and/or to thermally insulate hot fuels from the sidewalls and top lid of the grill. Portable versions of the grill collapse like a suitcase (with all grill components contained therein), fold-up legs may be provided, side shelves may be attachable, and/or a rotisserie rod may be added.

U.S. Pat. No. 6,250,211 discloses a barbecue mechanism that includes a lower casing member enclosing the heating medium for the cooking process. A gear driven spit arm is located above the cooking area, and is movable from a rearward position over the cooking area outwardly by way of linkage arms, to a position proximate outer side of the lower casing member. In this manner, food to be cooked can be loaded on the spit arm for the cooking process. A multi-part cover is also included, which includes a fixed portion mounted to the lower casing member, and a pivotable portion which pivots relative to the fixed portion and defines an opening into which the spit arm rotates when it is in its fully forward position.

U.S. Pat. No. 6,330,853 discloses a rotisserie that comprises an oven having a space for receiving objects used for broiling, two brackets each including at least one pair of parallel elongate openings, at least one longitudinal groove coupled the elongate openings of each pair together, at least one fastener driven through openings to secure bracket to the front or the rear side of oven, and a recess disposed at one end thereof A motor having at least one fastening member is put on one bracket, a telescopic bar with one end inserted into motor and the other end rotatably supported on the recess. Two opposite forks are on the bar. The distance between a broiled thing and the fire in oven, i.e., the height of brackets and bar, may be adjusted by adjusting the positions of fasteners in openings.

U.S. Pat. No. 6,465,760 discloses a rotisserie grill that includes a control device that alternates heat generation by a plurality of heating elements disposed at the periphery of a cooking chamber. The alternating heat evenly cooks food in a manner similar to a traditional rotisserie, while eliminating the need for food-rotating apparatus. The control device is a timer, which rotates a cam having a profile that actuates a switch. Heating elements are connected to the switch such that when one is energized, the other is not energized. The on/off cycle produced by the rotating cam repeats every 1 to 2 minutes. The rotisserie grill may be provided with multiple heating elements controlled by multiple switches. More than one cam may be employed to actuate the multiple switches in a complex pattern to simulate relative movement between the heating elements and the food.

U.S. Pat. No. 6,526,877 discloses a frame having a first end and a second end and a plurality of discrete heating stations spaced along the frame between the first end and the second end. A plurality of spits are moved along the frame, each spit supporting a meat product thereon. An advancement and driving mechanism advances the spits from one discrete heating station to the next in sequential fashion, and is operative to ensure that each spit resides within in the rotisserie for a pre-determined length of time to ensure that the meat is properly cooked, thereby avoiding undercooking and overcooking.

U.S. Pat. No. 6,539,843 discloses a vertical hearth barbecue grill having a removable, vertical firebox that is backwardly inclined so as to provide a combination of direct and indirect heating. Multiple cooking grids positionable at various heights across the firebox provide an substantial cooking area for grilling, broiling, and searing. Inclination minimizes ash avalanche during briquette burning. A top grid located directly over the firebox provides a surface for searing or high-temperature cooking (i.e., direct heating), a mid-level cooking grid provides medium temperature indirect and/or partial direct heating cooking, and a lower main cooking grid provides indirect medium temperature for broiling or baking. A pair of opposed insulated sidewalls help confine heat in and about the cooking grids and may also support a removable, hinged cover lid that establishes an oven-like enclosure about the mid-level and main cooking grids to provide a baking/broiling chamber. Portable versions of the grill collapse like a suitcase (with all grill components contained therein), fold-up legs may be provided, side shelves may be attachable, and/or a rotisserie rod may be added.

U.S. Pat. No. 6,640,797 discloses a grill assembly for cooking over an open fire at a campsite comprising a stake from which a grill is cantilevered outwardly and suspended over an open fire. The stake is driven into the ground or guide wire supported as desired. The grill is rotatable about the stake and adjustable along the vertical length of the stake and securable at any height above the fire by a frictional engagement with the stake. The frictional engagement comprises a binding ring disposed about the stake that binds to the stake as a result of the center of gravity being radially outward from the stake. The grill also comprises accessory pieces such as a hook for hanging a cooking pot, a secondary grill platform for more grilling space, for warming, or for support for a cutting board, and a rotisserie attachment for slow roasting food. The accessories are each secured to the stake above the grill or below the grill, as desired, by frictional engagement with the stake. This frictional engagement is by a helical ring that can be attached or removed laterally or angularly instead of coaxially or longitudinally of the stake. The grill and each of the accessories each are of steel or iron construction, and corrosion and other wear scours and actually enhances the binding action of the frictional engagement means for the grill and each of the accessories.

U.S. Pat. No. 6,658,991 discloses a rotisserie spit kit adapted to use on a barbeque grill. The rotisserie spit assembly includes a spit rod, a circular set of geared teeth, two stud axles, and two spit rods. The kit also includes two brackets that can be mounted onto the barbeque grill. The kit also includes a motor that can be mounted onto one of the brackets. The motor includes a drive shaft and a drive gear. Each of the brackets have a plurality of detents or recessed positions that can receive one of the stud axles such that the spit rods are in a generally horizontal position.

U.S. Pat. No. 7,001,627 discloses a rotisserie oven comprising a central heating section having a vertical orientation and dividing the cooking space into two equal, independent, and evenly heated roasting chambers. At least two rotisserie rods are each driven by a motor, at least two removable basting troughs are positioned above the rotisserie rods, and at least two drip collection pans are positioned below the rotisserie rods. An ash drawer is positioned below the central heating section. By inserting a basting fluid in the basting troughs, the roasting meat is automatically basted with the dripping basting fluid. The excess basting fluid and the meat juices is collected and can easily be recycled during the roasting process. By providing parts that are removable and have a simple mechanical design, cleaning and maintenance can be kept at a minimum. Mounting the rotisserie oven on top of cabinet results in added convenience, accessibility, and flexibility.

U.S. Pat. No. 7,159,509 discloses an outdoor cooking machine including a combination of horizontal and vertical smoker/grills. A vertical smoker/grill is connected to a horizontal smoker/grill by a tube with a damper. A variety of outdoor cooking techniques are provided, singly or in combination, by the outdoor cooking machine. Among these cooking techniques are: cold/slow smoking, hot smoking, steaming, double boiling, deep frying, stewing, food warming, spit/rotisserie cooking, conventional grilling, baking, an open fire pit function, an outdoor fireplace function, and a tabletop function. Some cooking techniques use a single fire while others combine multiple fires from one or more smoker/grills to enhance and/or change cooking options.

U.S. Pat. No. 7,707,928 discloses a vertical rotisserie sub-assembly, comprising: (a) a housing; (b) a motor; (c) an energy source; (d) a switch; (e) a rotating member; (f) a lower suspending member; and (g) an upper suspending member.

U.S. Pat. No. 7,856,924 discloses a cooking apparatus that has a food support with food engaging structure, such as a rotisserie spit. A fire bed is mounted under the food support to heat food at the food support. A heat reflective vault is mounted over the food support for reflecting radiant heat back down toward the food support. The vault extends over the food support while still providing access from the side. A drive mechanism can vertically adjust the fire bed to adjust heat flowing toward the food support. An elevator motor may be coupled to the drive mechanism for vertically positioning the fire bed. A thermostat responsive to heat from the fire bed and coupled to the elevator motor can control elevation of the fire bed.

U.S. Pat. No. 7,921,768 discloses a stand-alone oven capable of being utilized in both the horizontal and vertical orientations/positions to, among other functions, provide for rotisserie cooking of foodstuffs. The oven includes a rotisserie attachment that is adjustable to rotate in the oven in the horizontal and vertical orientation. A control panel is coupled to the oven to control the operation of the oven and includes a screen that is rotatable to be viewable in the horizontal and vertical orientation of the oven.

U.S. Pat. No. 8,051,768 discloses a retractable rotisserie driver which is used in connection with a barbecue grill. A retractable motor support apparatus is pivotably connected to a side shelf assembly of a barbecue grill, and is movable between a storage position, where the rotisserie motor is substantially enclosed by the side shelf assembly, and a usage position, where the motor is generally aligned for engagement with a rotisserie spit. The support apparatus includes a first wall and a second wall which are adjacent and generally transverse to one another. The first wall is configured to be aligned generally flush with an upper surface of the side shelf assembly when the support apparatus is moved to the storage position to increase the usable work area on the shelf The second wall is provided with a power cord holder for compactly holding the motor's power cord when the apparatus is moved to the storage position. The side shelf assembly and support apparatus are also provided with corresponding latch mechanisms which are adapted to engage when the support apparatus is moved to the usage position.

U.S. Pat. No. 8,272,321 discloses a removable rotisserie accessory for an oven that includes a motor assembly positionable beneath a floor of the oven to provide rotational energy about a vertical axis perpendicular to the floor of the oven. A vertical rod is insertable through an opening in the floor of the oven to engage the motor assembly and to rotate about the vertical axis. A horizontal rod has a first end supported by the vertical rod and has a second end supported proximate to a sidewall of the oven. The horizontal rod supports at least one engagement device for an item to be cooked. A miter gear assembly includes a first bevel gear mounted on the vertical rod to rotate with the vertical rod and includes a second bevel gear mounted on the horizontal rod to rotate the horizontal rod in response to rotation of the first bevel gear.

U.S. Pat. No. 8,387,518 discloses a vertical rotisserie open flame oven having a central flame post dispersing aesthetically pleasing flames and a secondary heater positioned outside the path of rotation of the food items. The oven has a central chamber area where the heat transfer to the food items is executed in a desirable manner to properly cook the food items without burning the surface thereof.

U.S. Pat. No. 8,408,120 discloses a generally vertically disposed rotisserie broiler. The broiler includes a metal housing with side walls, a floor, and an open end. One or more burners are disposed on opposite side walls of the housing. A generally vertically disposed spit is normally contained within the confines of the metal housing, but is movable towards the open end of the housing. The spit is rotated by a motor. The rotisserie broiler also includes an upper generally horizontal arm, and a lower generally horizontal arm, positioned adjacent an upper end and a lower end of the spit, respectively, for moving the spit transversely within the housing.

U.S. Pat. No. 8,516,952 discloses a rotisserie broiler for skewered food items including a horizontal conveyor defining a horizontal path of travel between a skewer receiving area and a transfer channel. The horizontal conveyor has a parallel pair of feeder chains to endlessly convey at a same rate to the transfer channel and a vertical conveyor disposed perpendicular to the horizontal conveyor at the transfer channel and defining a vertical path of travel between the transfer channel and a dispenser. The vertical conveyor has a parallel pair of rotisserie chains to endlessly convey at the same rate from the transfer channel to the dispenser. The food items are placed into the rotisserie broiler on a conveyor in a generally horizontal plane and automatically picked up by a conveyor in a vertical plane to be broiled and rotated adjacent to heating elements and then dispersed.

U.S. Pat. No. 8,596,627 discloses an automobile rotisserie including a pair of support columns, a neck clamp clamped to each support column, a rotation assembly attached to each neck clamp, a swing arm clamp attached to each rotation assembly, a swing arm received in and clamped by each swing arm clamp, a balancing assembly effective for controlling the movement and positioning of the swing arm within the swing arm clamp, and a mounting arm extending from each swing arm. Each neck clamp and/or swing arm clamp may include an L-shaped outer clamp plate and a W-shaped inner clamp plate. Each rotation assembly may include an outer sleeve attached to a neck clamp, an inner insert sleeve attached to a swing arm clamp, a plurality of ball bearings between the outer sleeve and the inner sleeve to facilitate rotational movement of the inner sleeve within the outer sleeve, and a retainer bearing to retain the inner sleeve within the outer sleeve. The balancing assembly may include a threaded balancer block attached to a swing arm clamp, an unthreaded balancer block attached to a swing arm, a threaded rod extending through the threaded balancer block and through the unthreaded balancer block, a gripping head at one end of the threaded rod, a thrust bearing assembly sandwiching the unthreaded balancer block, and a locking collar fixed to the threaded rod adjacent the thrust bearing assembly and the unthreaded balancer block.

U.S. Pat. No. 8,677,891 discloses a compact portable charcoal-fired barbecue cooker convertible for rotisserie cooking or for grill cooking. The cooker has a fire basket or charcoal grate, which can swing or rotate between a lowered, horizontal position, used for grilling, and a raised or upright position, used for rotisserie cooking, by turning a handle positioned outside the cooker body. The rotisserie spit drops into receptacles formed in the left and right side walls of the cooker body, and with the charcoal grate upright, a drip pan can be positioned under the spit. The vents are positioned so the heated air flows over the roast. A reflector or heat shield is positioned between the upright fire basket and the rear wall of the cooker. A locking tab can releasably retain the handle in the upright position. The entire cooker can be picked up using the handle affixed to the lid.

What is needed in the art is an apparatus that holds food over the cooking space of a grill such that the cooking space is maximized and such that the physical profile of the food is as narrow as possible for more even heat distribution and the food has less chance of burning.

### SUMMARY

The present invention addresses the above-mentioned need by providing a rotisserie assembly for use with a grill, that maintains food (e.g., meat) in a vertical orientation while being rotated above a heat source. Consequently, the physical profile of the meat in a direction vertically above the heat source is as narrow as possible.

In a first exemplary embodiment, the present invention comprises a universal rotatable cooking assembly for use with a grill, said cooking assembly comprising: a horizontally disposed rotisserie rod, said rod having first and second rod ends; a first skewer apparatus, said first skewer apparatus disposed perpendicularly relative to said rod and releasably connected to said rod between said first and second ends of said rod, said first skewer apparatus comprising first and second skewer apparatus ends, each said skewer apparatus end including at least one prong, each of said at least one prong disposed generally parallel to said rod with prong tips facing the first end of said rod; a second skewer apparatus, said second skewer apparatus disposed perpendicularly relative to said rod and releasably connected to said rod between said first end of said rod and first skewer apparatus, said second skewer apparatus comprising first and second skewer apparatus ends, each of said skewer apparatus ends including at least one prong, each said at least one prong disposed generally parallel to said rod with prong tips facing the second end of said rod; and a handle, said handle mechanically connected to said first end of said rotisserie rod.

In a second exemplary embodiment, the present invention provides a cooking assembly wherein food is vertically rotated over a heat source, said cooking assembly comprising: a housing, said housing containing a heat source; a rotisserie rod, said rotisserie rod rotatably connected to said housing and disposed horizontally over said heat source, said rod having first and second rod ends; a first skewer apparatus, said first skewer apparatus disposed perpendicularly relative to said rod and releasably connected to said rod between said first and second ends of said rod, said first skewer apparatus comprising first and second skewer apparatus ends, each said skewer apparatus ends including at least one prong, each of said at least one prong disposed generally parallel to said rod with prong tips facing the first end of said rod; a second skewer apparatus, said second skewer apparatus disposed perpendicularly relative to said rod and releasably connected to said rod between said first end of said rod and first skewer apparatus, said second skewer apparatus comprising first and second skewer apparatus ends, each of said skewer apparatus ends including at least one prong, each said at least one prong disposed generally parallel to said rod with prong tips facing the second end of said rod; and a handle, said handle mechanically connected to said first end of said rotisserie rod.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a perspective assembly view of a rotisserie assembly according to the present invention.

FIG. 2 shows a perspective view of a skewer assembly shown in FIG. 1.

FIG. 3 shows an enlarged view of one end of a skewer assembly shown in FIG. 2.

FIG. 4 shows an enlarged view of one end of a skewer apparatus shown in FIG. 2.

FIG. 5 shows a perspective view of a cooking assembly embodiment comprising a grill having a housing containing a heat source, and to which the rotisserie assembly of FIG. 1 is rotatably connected, showing vertically oriented, cooking meat in ghosted lines.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

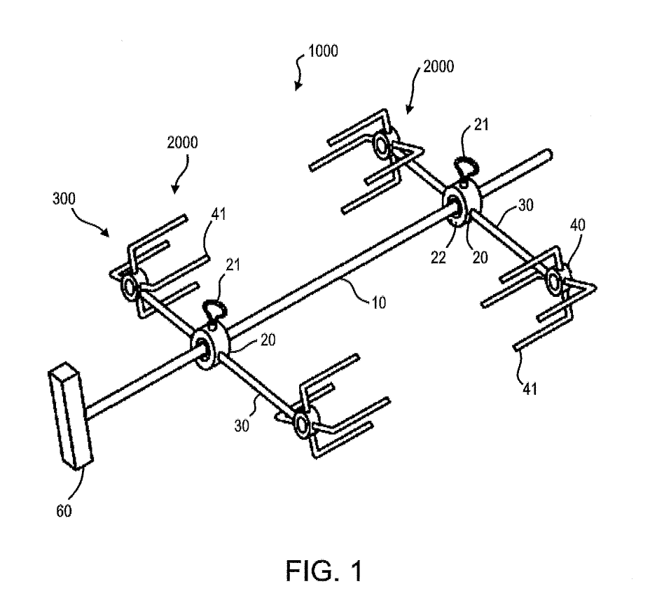

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown an embodiment of a rotisserie assembly according to the present disclosure. Rotisserie-assembly 1000 generally comprises an elongate rod 10 having a first end and a second end and a pair of skewer assemblies 2000 releasably and perpendicularly connected to rod 10 of rotisserie assembly 1000.

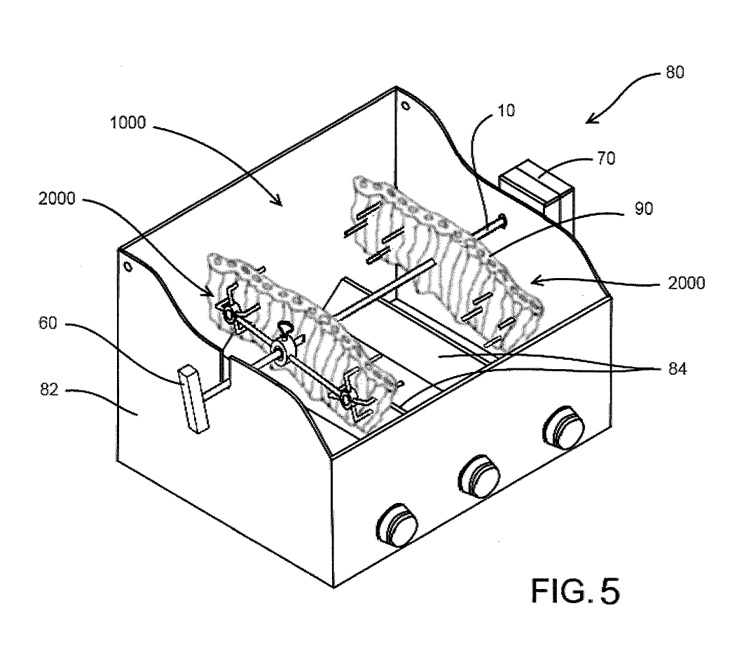

Referring still to FIG. 1, rod 10 for rotisserie assembly 1000 comprises a pair of opposing ends and is made of a heat resistant material, preferably a ceramic or metal, such as stainless steel. Rotisserie assembly 1000 further includes a means for rotating rod 10 about its longitudinal axis. Such means may include a human powered mechanism such as a handle 60 or a crank. Alternatively, rod 10 may be rotated by an electric or hydraulic motor 70 (FIG. 5).

Rod 10 of rotisserie assembly 1000 is releasably connected to food retention or skewer assembly 2000, two of which are shown spaced along rod 10. Skewer assembly 2000 holds the food (e.g., meat) in a particular longitudinal and angular orientation relative to rod 10 during cooking, while rod 10, skewer assemblies 2000 and the meat rotate in unison.

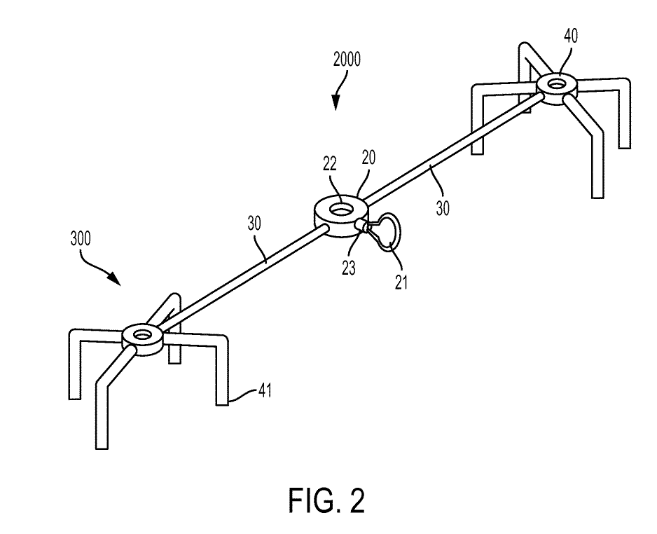

Referring now to FIG. 2, there is shown a detailed perspective view of an embodiment of a skewer assembly according to the present disclosure. Skewer assembly 2000 generally comprises a centrally located, cylindrical connector 20; a pair of collinearly disposed, elongate extension members 30; and a pair of skewer apparatuses 300. Each extension member 30 is connected at its respective, radially inward end to a radially outer portion of connector 20. Each skewer apparatus 300 is connected to the radially outward end of a respective extension member 30.

Each connector 20 has a generally cylindrical shape defining two opposing flat faces and a longitudinal axis along which a through-bore 22 extends between the connector's opposing flat faces. Each connector 20 is provided with threaded hole 23 extending radially between the curved exterior surface of connector 20 and its through-bore 22. As further illustrated in FIG. 2, set screw 21 is threadedly received in threaded hole 23 of connector 20 to selectively secure skewer assembly 2000 to rod 10.

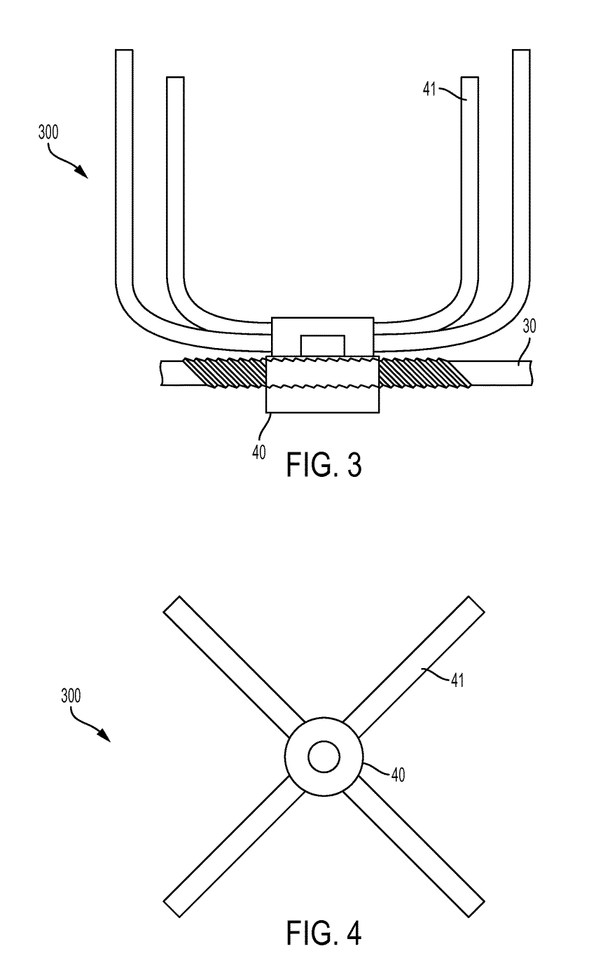

FIG. 3 and FIG. 4 respectively show enlarged views of a skewer apparatus 300. Each skewer apparatus 300 comprises base 40 and prongs 41. Those of skill in the art will appreciate that only a single prong 41 is needed, but a plurality of prongs 41 is preferred. Prongs 41 should comprise a stainless steel, ceramic or other heat resistant but food safe material. As further illustrated in FIG. 3, prongs 41 may be releasably or fixedly attached to base 40. Moreover, although prongs 41 are shown with a particular curved shape, those of skill in the art will appreciate that prongs 41 may alternatively extend straight from base 40 in a direction generally perpendicularly from extension member 30. Base 40 should comprise a robust heat resistant material such as stainless steel or iron.

Referring again to FIG. 3, it is shown that each base 40 is preferably releasably connected to respective extension member 30. In one exemplary embodiment, each extension member 30 is threadedly connected through a complimentarily threaded bore disposed through base 40. Thus, skewer apparatuses 300 may be rotated about the axes of the extension members 30 for installation thereto and removal therefrom, with their respective axial positions along extension members 30 (i.e., radially relative to the longitudinal axis of rod 10) adjustable by changing the relative positions between the interengaged male and female threads.

Turning again to FIG. 1, it is shown that rod 10 is slidingly received into bore 22 of connector 20. When rod 10 is properly positioned within connector 20, set screw 21 is threaded through hole 23 to selectively, releasably secure rod 10 in place in bore 22 of connector 20, whereby skewer assemblies 2000 are rotatable in unison with rod 10.

In use, rod 10 of rotisserie assembly 1000 is disposed through respective connectors 20 of first and second skewer assemblies 2000 such that each skewer assembly extension member 30 extends substantially perpendicularly to rod 10 of rotisserie assembly 1000.

FIG. 5 depicts one embodiment of a cooking assembly according to the present disclosure. Cooking assembly 80 comprises housing 82 in which is contained heat source 84. In some embodiments, housing 82 and heat source 84 are of a type defined by a prior rotisserie grill apparatus. Cooking assembly 80 includes above-mentioned motor 70 operably connectable to rod 10 for rotating rotisserie assembly 1000 about the longitudinal axis of rod 10.

Advantageously, rotisserie assembly 1000 of the present invention allows more food product to cook simultaneously within a particular cooking space, as indicated in FIG. 5. Additionally, rotisserie meats may be cooked at higher temperatures with less chance of burning thereby saving up to 75% cooking time and allowing food to cook more evenly. Moreover, rotisserie assembly 1000 of the present invention allows meats such as ribs to spin and “self baste”, unlike current methods of cooking on a rotisserie. Contamination of meat juices by dripping on other meats in a stacked arrangement is also eliminated.

Rotisserie assembly 1000 is thus capable of maintaining food retained thereto in a substantially vertical orientation while being cooked above a heat source, whereby the narrowest physical profile of the food is presented to the heat source at all angular positions of the rod about the longitudinal axis. Compared to prior rotisserie assemblies, the “edge on” presentation of the food to the heat source at all angular rotisserie positions, as facilitated by rotisserie assembly 1000, advantageously provides relatively greater heat distribution to the food while reducing the chance of its burning, and maximizes utilization of the available cooking space.

In use, a user places meat 90 on skewer prongs 41 of each skewer assembly 2000 such that, with rotisserie assembly 1000 installed, meat 90 is vertically oriented over a standard grill. Rotisserie assembly 1000 thus allows a user to evenly extend the meats outward from both sides of rod 10, thereby utilizing more of the available cooking space. Moreover, the vertical arrangement of meat presents a physical profile of the meat toward the heat source that is narrow rather than flat (broad), which helps achieve even heat distribution and the less chance of burning. The rotation of the vertically oriented meat also presents the meats toward the heat source in such a way so that both sides cook evenly.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. (canceled)

2. (canceled)

3. A rotisserie assembly for adjustably positioning vertically-oriented food disposed above a heat source, the rotisserie assembly comprising:
an elongate rod defining a longitudinal axis and having opposite first and second ends between which the longitudinal axis extends; and
a first skewer assembly connectable to the rod between the rod first end and the rod second end, the connected first skewer assembly and the rod adapted for rotation in unison about the longitudinal axis, the first skewer assembly comprising:
first and second skewer apparatuses substantially equidistantly spaced longitudinally from the rod first end, the first and second skewer apparatuses radially spaced from the longitudinal axis and positioned on generally opposite radial sides of the rod, each of the first and second skewer apparatuses respectively including at least one elongate prong adapted for retaining food to the first skewer assembly, the prongs extending in generally parallel directions relative to the rod;
wherein the rotisserie assembly has a selective installed state in which the rotisserie assembly is supported with the longitudinal axis in fixed vertically spaced relation above a heat source and the rod is selectively rotatable about the longitudinal axis; and
wherein the rotisserie assembly is capable of maintaining food retained to the first skewer assembly in a substantially vertical orientation, in which the retained food is arranged with its narrowest profile toward the heat source, at all angular positions of the rod about the longitudinal axis.

4. The rotisserie assembly of claim 3, wherein the first and second skewer apparatuses are radially spaced substantially equidistantly from the longitudinal axis.

5. The rotisserie assembly of claim 3, wherein each of the first and second skewer apparatuses respectively includes a plurality of elongate prongs.

6. The rotisserie assembly of claim 3, wherein each of the first and second skewer apparatuses is moveable generally perpendicularly relative to the longitudinal axis.

7. The rotisserie assembly of claim 6, wherein the respective positions of the first and second skewer apparatuses are adjustable radially relative to the longitudinal axis along threaded connections.

8. The rotisserie assembly of claim 3, further comprising a second skewer assembly connectable to the rod between the connected first skewer assembly and the rod second end, the connected second skewer assembly and the rod adapted for rotation in unison about the longitudinal axis, the second skewer assembly comprising:
third and fourth skewer apparatuses substantially equidistantly spaced longitudinally from the rod first end, the third and fourth skewer apparatuses radially spaced from the longitudinal axis and positioned on generally opposite radial sides of the rod, each of the third and fourth skewer apparatuses respectively including at least one elongate prong adapted for retaining food to the second skewer assembly, the prongs extending in generally parallel directions relative to the rod;
wherein the rotisserie assembly is capable of maintaining food respectively retained to the first skewer assembly and the second skewer assembly in substantially vertical orientations, in which the respectively retained food is arranged with its narrowest profile toward the heat source, at all angular positions of the rod about the longitudinal axis independently of each other.

9. The rotisserie assembly of claim 8, wherein the prongs of the first and second skewer apparatuses extend toward the rod first end, and the prongs of the third and fourth skewer apparatuses extend toward the rod second end.

10. The rotisserie assembly of claim 3, further comprising a handle mechanically connected to one of the rod first and second ends.

11. The rotisserie assembly of claim 3, wherein the first skewer assembly comprises:
a connector receivable of the rod, the first skewer assembly connectable to the rod through the connector; and
an extension member extending between the connector and at least one of the first and second skewer apparatuses in directions substantially perpendicular to the longitudinal axis.

12. The rotisserie assembly of claim 11, wherein the first skewer assembly comprises a pair of extension members, each extension member extending between the connector and a respective one of the first and second skewer apparatuses in directions substantially perpendicular to the longitudinal axis.

13. A cooking assembly for cooking vertically-oriented food adjustably positionable above a heat source, the cooking assembly comprising:
a housing;
a heat source contained by the housing; and
a selectively installed rotisserie assembly having an installed state in which the rotisserie assembly is supported by the housing, the rotisserie assembly comprising:
an elongate rod defining a longitudinal axis and having opposite first and second ends between which the longitudinal axis extends, wherein in the installed state the longitudinal axis is in fixed vertically spaced relation above the heat source and the rod is selectively rotatable about the longitudinal axis; and
a first skewer assembly connectable to the rod between the rod first end and the rod second end, the connected first skewer assembly and the rod adapted for rotation in unison about the longitudinal axis, the first skewer assembly comprising:
first and second skewer apparatuses substantially equidistantly spaced longitudinally from the rod first end, the first and second skewer apparatuses radially spaced from the longitudinal axis and positioned on generally opposite radial sides of the rod, each of the first and second skewer apparatuses respectively including at least one elongate prong adapted for retaining food to the first skewer assembly, the prongs extending in generally parallel directions relative to the rod;
wherein the rotisserie assembly is capable of maintaining food retained to the first skewer assembly in a substantially vertical orientation, in which the retained food is arranged with its narrowest profile toward the heat source, at all angular positions of the rod about the longitudinal axis.

14. The cooking assembly of claim 13, wherein the first and second skewer apparatuses are radially spaced substantially equidistantly from the longitudinal axis.

15. The cooking assembly of claim 13, wherein each of the first and second skewer apparatuses respectively includes a plurality of elongate prongs.

16. The cooking assembly of claim 13, wherein each of the first and second skewer apparatuses is moveable generally perpendicularly relative to the longitudinal axis.

17. The cooking assembly of claim 16, wherein the respective positions of the first and second skewer apparatuses are adjustable radially relative to the longitudinal axis along threaded connections.

18. The cooking assembly of claim 13, wherein the rotisserie assembly further comprises a second skewer assembly connectable to the rod between the connected first skewer assembly and the rod second end, the connected second skewer assembly and the rod adapted for rotation in unison about the longitudinal axis, the second skewer assembly comprising:
third and fourth skewer apparatuses substantially equidistantly spaced longitudinally from the rod first end, the third and fourth skewer apparatuses radially spaced from the longitudinal axis and positioned on generally opposite radial sides of the rod, each of the third and fourth skewer apparatuses respectively including at least one elongate prong adapted for retaining food to the second skewer assembly, the prongs extending in generally parallel directions relative to the rod;
wherein the rotisserie assembly is capable of maintaining food respectively retained to the first skewer assembly and the second skewer assembly in substantially vertical orientations, in which the respectively retained food is arranged with its narrowest profile toward the heat source, at all angular positions of the rod about the longitudinal axis independently of each other.

19. The cooking assembly of claim 18, wherein the prongs of the first and second skewer apparatuses extend toward the rod first end, and the prongs of the third and fourth skewer apparatuses extend toward the rod second end.

20. The cooking assembly of claim 13, further comprising a handle mechanically connected to one of the rod first and second ends.

21. The cooking assembly of claim 13, wherein the first skewer assembly comprises:
a connector receivable of the rod, the first skewer assembly connectable to the rod through the connector; and
an extension member extending between the connector and at least one of the first and second skewer apparatuses in directions substantially perpendicular to the longitudinal axis.

22. The cooking assembly of claim 13, wherein the first skewer assembly comprises a pair of extension members, each extension member extending between the connector and a respective one of the first and second skewer apparatuses in directions substantially perpendicular to the longitudinal axis.
